(19) United States
(12) Patent Application Publication
(10) Pub. No.: US 2020/0117210 A1
(43) Pub. Date: Apr. 16, 2020

(54) Auto-Exploration Control of a Robotic Vehicle

(71) Applicant: QUALCOMM Incorporated, San Diego, CA (US)

(72) Inventors: Jiangtao REN, Beijing (CN); Yibo JIANG, Shanghai (CN); Xiaohui LIU, Lund (SE); Yanmin ZOU, Beijing (CN); Lei XU, Beijing (CN)

(21) Appl. No.: 16/621,565

(22) PCT Filed: Jul. 28, 2017
(86) PCT No.: PCT/CN2017/094901

§ 371 Date: Dec. 11, 2019

(51) Int. Cl. G05D 1/02; G06T 7/73; G06K 9/62; G06K 9/00

(52) U.S. Cl. CPC G05D 1/0246; G05D 1/0212; G05D 1/0274; G06T 2207/30244; G06K 9/6267; G06K 9/00664; G05D 2201/0207; G06T 7/73

(57) ABSTRACT

Various embodiments include processing devices and methods for classifying areas close to the robotic vehicle as feature-rich or feature-poor based, at least in part, on identified environmental features. A processor may select a target position based, at least in part, on the classified areas and the path costs, and initiate movement of the robotic vehicle toward the selected target position. Occasionally during transition of the robotic vehicle, the processor may determine whether the robotic vehicle has reached the target position and in response to determining that the robotic vehicle has not reached the target position, the processor may adjust the robotic vehicle's trajectory. For example, the processor may perform localization of the robotic vehicle based, at least in part, on the classified areas and may also modify a path of the robotic vehicle to the target position based, at least in part, on the localization and the classified areas.

### BACKGROUND

Robotic vehicles are being developed for a wide range of applications. Robotic vehicles may be equipped with cameras capable of capturing an image, a sequence of images, or videos. Some robotic vehicles may be equipped with a monocular image sensor, such as a monocular camera. Captured images may be used by the robotic vehicle to perform vision-based navigation and localization. Vision-based localization and mapping provides a flexible, extendible, and low-cost solution for navigating robotic vehicles in a variety of environments. As robotic vehicles become increasing autonomous, the ability of robotic vehicles to detect and make decisions based on environmental features becomes increasingly important.

### SUMMARY

Various embodiments include methods that may be implemented in robotic vehicles and processing devices within robotic vehicles for controlling auto-exploration. Various embodiments may include classifying areas in proximity to the robotic vehicle as feature-rich or feature-poor based, at least in part, on identified environmental features, selecting a target position based, at least in part, on the classified areas, determining a path to the target position, initiating movement of the robotic vehicle toward the selected target position, determining a pose of the robotic vehicle, determining whether the robotic vehicle has reached the target position based, at least in part, on the determined pose of the robotic vehicle, determining whether the determined path is a best path in response to determining that the robotic vehicle has not reached the target position, and modifying the determined path of the robotic vehicle to the target position based, at least in part, on the classified areas in response to determining that the determined path is not the best path.

In some embodiments, selecting the target position based, at least in part, on the classified areas may include identifying frontiers of a current map of the robotic vehicle's location, determining respective frontier centers of the identified frontiers, and selecting a frontier based, at least in part, on the determined frontier centers. In such embodiments, modifying the determined path of the robotic vehicle to the target position based, at least in part, on the classified areas in response to determining that the determined path is not the best path may include determining a distance from the robotic vehicle to a destination between the determined pose and the target position, determining a number of rotations and angles of the rotations between the robotic vehicle and the destination, determining a path cost based, at least in part, on the classified areas, the determined distance, and the determined number of rotations and angles of the rotations, and selecting a new path based, at least in part, on the determined path costs.

Some embodiments may further include capturing an image of the environment, executing tracking on the captured image to obtain a current pose of the robotic vehicle, determining whether the current pose of the robotic vehicle was obtained, determining whether the robotic vehicle's current location is a previously visited location in response to determining that the current pose of the robotic vehicle was not obtained, and performing target-less initialization using the captured image in response to determining that the robotic vehicle's current location is not a previously visited location. Such embodiments may further include in response to determining that the robotic vehicle's current location is a previously visited location: executing re-localization on the captured image to obtain the current pose of the robotic vehicle, determining whether the current pose of the robotic vehicle was obtained; determining whether a number of failed attempts to obtain the current pose of the robotic vehicle exceeds an attempt threshold in response to determining that the current pose of the robotic vehicle was not obtained; and performing target-less initialization in response to determining that the number of failed attempts to obtain the current pose of the robotic vehicle exceeds an attempt threshold.

In some embodiments, performing target-less initialization using the captured image may include determining whether the robotic vehicle's location is in an area that is classified as feature-rich, and executing target-less initialization on the captured image to obtain the current pose of the robotic vehicle in response to determining that the robotic vehicle's location is in an area that is classified as feature-rich. Such embodiments may further include refrain from performing localization for a period of time in response to determining that the robotic vehicle's location is in an area that is not classified as feature-rich.

In some embodiments, the target position may lie on a frontier between mapped and unknown areas of an environment. In some embodiments, the environmental features may include physical terrain, contour, and visual elements of an environment.

Various embodiments may include a robotic vehicle having an image sensor and a processor configured with processor-executable instructions to perform operations of any of the methods summarized above. Various embodiments may include a processing device for use in a robotic vehicle configured to perform operations of any of the methods summarized above. Various embodiments may include a robotic vehicle having means for performing functions of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a robotic vehicle operating within communication system according to various embodiments.

FIG. 2 is a component block diagram illustrating components of a robotic vehicle according to various embodiments.

FIG. 3 is a component block diagram illustrating a processing device suitable for use in robotic vehicles implementing various embodiments.

FIG. 4 is a component block diagram illustrating components of an image capture and processing system of a robotic vehicle suitable for use with various embodiments.

FIG. 5 is a system block diagram of a robotic vehicle during path planning according to various embodiments.

FIG. 6 is a system block diagram of a robotic vehicle selecting a target position according to various embodiments.

FIG. 7 is a process flow diagram illustrating a method of controlling auto-exploration by a robotic vehicle according to various embodiments.

FIG. 8 is a process flow diagram illustrating a method of selecting a target location during auto-exploration of a robotic vehicle according to various embodiments.

FIG. 9 is a process flow diagram illustrating a method of calculating a cost of potential auto-exploration paths for a robotic vehicle according to various embodiments.

FIG. 110 is a process flow diagram illustrating a method of selecting between re-localization and environment based re-initialization after failing to track in a robotic vehicle according to various embodiments.

FIG. 11 is a process flow diagram illustrating a method of performing re-localization in a robotic vehicle according to various embodiments.

FIG. 12 is a process flow diagram illustrating a method of performing environment based re-initialization in a robotic vehicle according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include methods that may be implemented on a processor of a robotic vehicle for controlling auto-exploration by the robotic vehicle. Various embodiments may enable a processor of the robotic vehicle to identify environmental features of an area surrounding the robotic vehicle and classify areas of the environment as “feature-rich” and “feature-poor.” The processor of the robotic vehicle may then prioritize localization operations according to the feature-richness of areas of its surrounding environment. The processor of the robotic vehicle may further select a target position and a path to the target position in order to decrease the probability of passing through the feature-poor areas of the environment, thereby reducing the likelihood that the robotic vehicle will become disoriented and lost due to lack of recognizable environmental features. Thus, various embodiments may enable robotic vehicles to more efficiently and effectively auto--explore the surrounding environment, by selecting a target and a path between the current localization to the selected target that prioritizes the feature-rich environment during auto-exploration.

Various embodiments include processing devices and methods for classifying areas in proximity to the robotic vehicle as feature-rich or feature-poor based, at least in part, on identified environmental features. A processor may select a target position based, at least in part, on the classified areas and the path costs. Based on this, the processor may initiate movement of the robotic vehicle toward the selected target position. At some point during transition of the robotic vehicle, the processor may determine whether the robotic vehicle has reached the target position and in response to determining that the robotic vehicle has not reached the target position, the processor may adjust the robotic vehicle's trajectory. For example, the (processor may perform localization of the robotic vehicle based, at least in part, on the classified areas and may also modify a path of the robotic vehicle to the target position based, at least in part, on the localization and the classified areas. To decrease localization failure, the robotic vehicle's path trajectory and the environmental feature level may be used to determine whether to perform re--localization or target-less initialization or wait for the robotic vehicle to move to feature-rich environment to perform target-less initialization after failing to tracking.

As used herein, the tem “robotic vehicle” refers to one of various types of vehicles including an onboard processing device configured to provide some autonomous or semi-autonomous capabilities. Examples of robotic vehicles include hut are not limited to: aerial vehicles, such as an unmanned aerial vehicle (UAV); ground vehicles (e.g., an autonomous or semi-autonomous car, a vacuum robot, etc.); water-based vehicles (i.e., vehicles configured for operation on the surface of the water or under water); space-based vehicles (e.g., a spacecraft or space probe); and/or some combination thereof. In some embodiments, the robotic vehicle may be manned. In other embodiments, the robotic vehicle may be unmanned. In embodiments in which the robotic vehicle is autonomous, the robotic vehicle may include an onboard computing device configured to maneuver and/or navigate the robotic vehicle without remote operating instructions (i.e., autonomously), such as from a human operator (e.g., via a remote computing device). In embodiments in which the robotic vehicle is semi-autonomous, the robotic vehicle may include an onboard computing device configured to receive some information or instructions, such as from a human operator (e.g., via a remote computing device), and autonomously maneuver and/or navigate the robotic vehicle consistent with the received information or instructions. In some implementations, the robotic vehicle may be an aerial vehicle (unmanned or manned), which may be a rotorcraft or winged aircraft. For example, a rotorcraft (also referred to as a multirotor or multicopter) may include a plurality of propulsion units (e.g., rotors/propellers) that provide propulsion and/or lifting forces for the robotic vehicle. Specific non-limiting examples of rotorcraft include tricopters (three rotors), quadcopters (four rotors), hexacopters six rotors), and octocopters (eight rotors). However, a rotorcraft may include any number of rotors. A robotic vehicle may include a variety of components and/or payloads that may perform a variety of functions.

As used herein, the term “environmental features” refers to various types of terrain elements. Examples of environmental features include terrain contours, physical barriers, buildings, waterways, trees and other natural obstructions, temporary obstructions such as automobiles and other vehicles, illumination levels, weather effects, anti the like. In some embodiments, environmental features may be those features detectable by a monocular image sensor of a robotic vehicle. In some embodiments, environmental features may be those features detectable by two or multi-image sensors. In some embodiments, environmental features may be features detectable by any sensor of the robotic vehicle such as ultrasound, infrared, binocular image sensors, etc.

Robotic vehicles performing exploration operations may generate maps of explored areas. In some embodiments, portions of the map may be classified as 1) “free,” areas that have been explored and are known to the robotic vehicle to be free of obstacles; 2) “occupied,” areas that are known to the robotic vehicle to be obstructed or covered by an obstacle; and 3) unknown, areas that have not yet to be explored by the robotic vehicle. Unknown areas may be areas that have been not been captured by the image sensor of the robotic vehicle, or if captured in an image, have not yet to be analyzed by the processor of the robotic vehicle. Any area above a threshold size that abuts a free and an unknown region may be treated as a “frontier” region. Auto-exploration by a robotic vehicle involves the movement of the robotic vehicle into frontier regions and the continuous capture and analysis of images of unknown areas as the robotic vehicle moves along the frontier regions. With each traversal of frontier regions, more area within maps maintained by the robotic vehicle processor is converted from unknown to free or occupied. The shape of the free/occupied areas within maps maintained by the robotic vehicle processor may change as new frontier regions are identified and explored by the robotic vehicle. Similarly, the features of the surrounding environment within maps maintained by the robotic vehicle processor may change during auto-exploration by the robotic vehicle, whether because features have moved, or because the robotic vehicle has entered a new area. Such changes in environmental features within maps maintained by the robotic vehicle processor create challenges for vision-based robotic vehicle navigation.

Robotic vehicles may employ simultaneous localization and mapping (SLAM) techniques to construct and update a map of an unknown environment while simultaneously keeping track of the robotic vehicle's location within the environment. Robotic vehicles are increasingly equipped with image sensor devices for capturing images and video. In some embodiments, the image sensor device may include a monocular image sensor (e.g., a monocular camera). A robotic vehicle may gather data useful for SLAM using the image sensor device.

Robotic vehicles performing SLAM techniques are highly reliant on the presence of distinguishable features in the surrounding environment. A lack of recognizable or distinguishable features may cause localization and mapping operations to fail, and may result in the robotic vehicle becoming “lost” or otherwise unable to reach a target position. Although the navigation of many robotic vehicles is dependent upon distinguishing a variety of environmental features, existing techniques for robotic vehicle navigation fail to account for or prioritize the richness of available environmental features when navigating robotic vehicles. Most robotic vehicles select target positions and associated paths by identifying the closest desired position and determining the shortest, unobstructed path to that position.

Vision-based localization and mapping techniques are highly dependent on the feature level of the environment, which may be uncontrollable. Thus, robotic vehicles implementing such techniques must be able to adjust to a variety of feature levels in the surrounding environment. Auto-exploration further requires that a robotic vehicle be able to quickly and efficiently adjust to a variety of environmental levels without requiring user intervention. Many robotic vehicles employ re-localization when they become lose or disoriented. For example, the robotic vehicle may move, capture a second image, and attempt to match environmental elements within the captured image to environmental elements within a known or mapped area. Such techniques may be effective in previously explored feature-rich areas, but may fail entirely when the robotic vehicle begins to explore unknown areas.

Exploratory robotic vehicles must also select target positions and plan attainable paths to those target positions. Robotic vehicles may identify a target position for further exploration and may plot a course to the target position based on only the size of the robotic vehicle, the length of the path, and the ability of the robotic vehicle to traverse the path. For example, a robotic vehicle may optimize path selection in order to find the shortest path that is free of obstructions too large for the robotic vehicle to traverse (e.g., crawl over, around, under, etc.). Localization, and consequently environmental feature levels, are not taken into account during path planning. As a result, a robotic vehicle that enters an area devoice of environmental features while travelling the path to the target position may become lost and disoriented, with no way to ascertain its bearings.

In various embodiments, a processor device of the robotic vehicle may classify areas in proximity to the robotic vehicle as feature-rich or feature-poor based, at least in part, on identified environmental features. For example, the processor may compare environmental features indicated by the output of various sensors to a feature threshold in order to determine whether the feature content of the area is rich or poor. The processor may select a target position based, at least in part, on the classified areas and may then initiate movement of the robotic vehicle toward the selected target position. At some point during transition of the robotic vehicle, the processor may determine whether the robotic vehicle has reached the target position and in response to determining that the robotic vehicle has not reached the target position, the processor may adjust the robotic vehicle's trajectory. For example, the processor may perform localization of the robotic vehicle based, at least in part, on the classified areas and may also modify a path of the robotic vehicle to the target position based, at least in part, on the localization and the classified areas.

Various embodiments may decrease the probability of localization failure by a robotic vehicle performing auto-exploration operations by accounting for variations in environmental feature levels. During auto-exploration, the robotic vehicle may occasionally, regularly, periodically, or otherwise schedule analysis of environmental features in the surrounding environment. If at any point attempts to re-localize the robotic vehicle fail, the processor of the robotic vehicle may initiate target-less localization by comparing and distinguishing environmental features. The processor may, also engage in dynamic path planning by navigating the robotic vehicle to the shortest path that lies primarily within environmental feature-rich areas in order to minimize the likelihood that the robotic vehicle will become lost along the path (i.e., that localization will fail). Various embodiments may also include the processor navigating the robotic vehicle into a pose and orientation near a frontier region that is feature-rich in order to increase the level of environment detail information that is obtained through image capture of unknown areas.

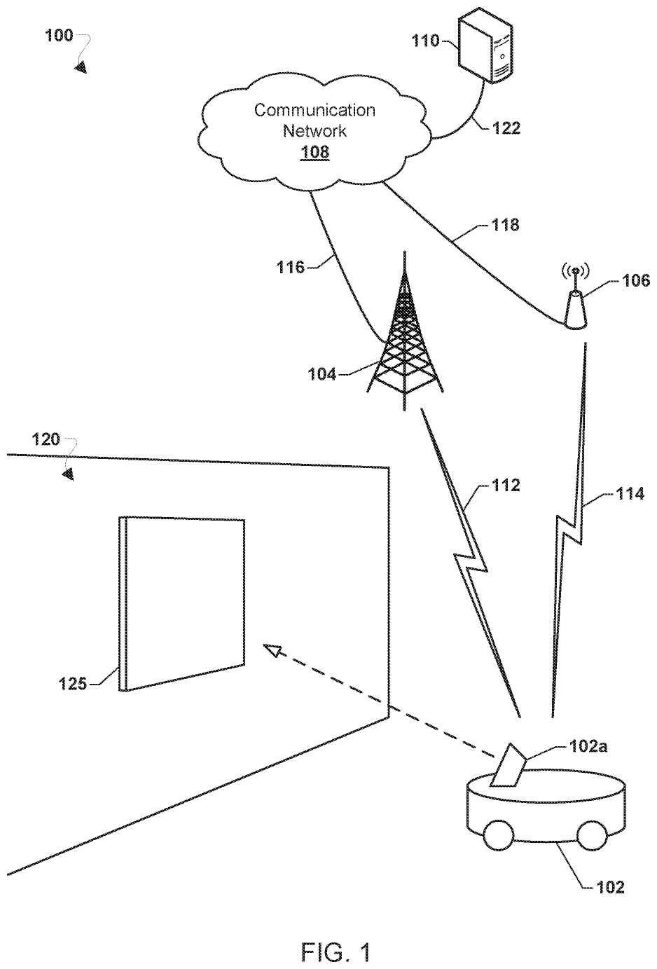

Various embodiments may be implemented within a robotic vehicle operating within a variety of communication systems 100, an example of which is illustrated in FIG. 1. With reference to FIG. 1, the communication system 100 may include a robotic vehicle 102, a base station 104, an access point 106, a communication network 108, and a network element 110. In some embodiments, the robotic vehicle 120 may be equipped with an image sensor 102a. In sonic embodiments, the image sensor 102a may include a monocular image sensor.

The base station 104 and the access point 106 may provide wireless communications to access the communication network 108 over a wired and/or wireless communication backhaul 116 and 118, respectively. The base station 104 may include base stations configured to provide wireless communications over a wide area (e.g., macro cells), as well as small cells, which may include a micro cell, a femto cell, a Pico cell, and other similar network access points. The access point 106 may include access points configured to provide wireless communications over a relatively smaller area. Other examples of base stations and access points are also possible.

The robotic vehicle 102 may communicate with the base station 104 over a wireless communication link 112, and with the access point 106 over a wireless communication link 114. The wireless communication links 112 and 114 may include a plurality of carrier signals, frequencies, or frequency bands, each of which may include a plurality of logical channels. The wireless communication links 112 and 114 may utilize one or more radio access technologies (RATs). Examples of RATs that may be used in a wireless communication link include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

The network element 110 may include a network server or another similar network element. The network element 1110 may communicate with the communication network 108 over a communication link 122. The robotic vehicle 102 and the network element 110 may communicate via the communication network 108. The network element 110 may provide the robotic vehicle 102 with a variety of information, such as navigation information, weather information, information about local air, ground, and/or sea traffic, movement control instructions, and other information, instructions, or commands relevant to operations of the robotic vehicle 102.

In various embodiments, the robotic vehicle 102 may move in an environment 120. In some embodiments, the robotic vehicle may use the image sensor 102a to capture one or more images of a target image 125 in the environment 120. In some embodiments, the target image 125 may include a test image, which may include known characteristics, such as a height and a width.

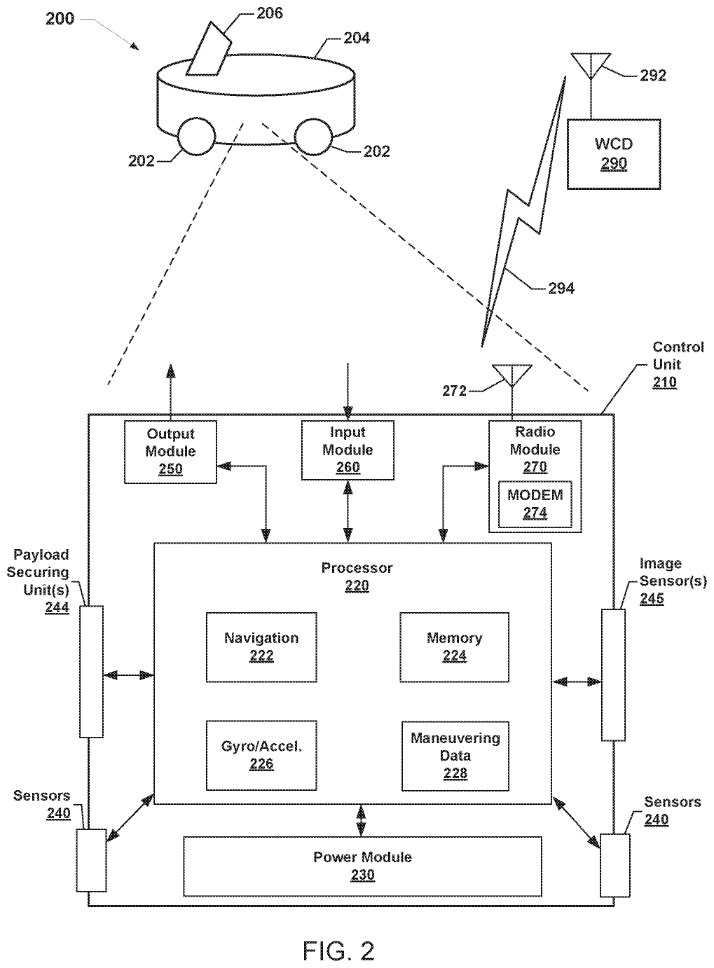

Robotic vehicles may include winged or rotorcraft varieties. FIG. 2 illustrates an example robotic vehicle 200 of a ground vehicle design that utilizes one or more wheels 202 driven by corresponding motors to provide locomotion to the robotic vehicle 200. The robotic vehicle 200 is illustrated as an example of a robotic vehicle that may utilize various embodiments, but is not intended to imply or require that various embodiments are limited to ground robotic vehicles. For example, various embodiments may be used with rotorcraft or winged robotic vehicles, water-borne robotic vehicles, and space-based robotic vehicles.

With reference to FIGS. 1 and 2, the robotic vehicle 200 may be similar to the robotic vehicle 102. The robotic vehicle 200 may include a number of wheels 202, a body 204, and an image sensor 206. The frame 204 may provide structural support for the motors and their associated wheels 202 as well as for the image sensor 206. For ease of description and illustration, some detailed aspects of the robotic vehicle 200 are omitted such as wiring, frame structure interconnects, or other features that would be known to one of skill in the art. While the illustrated robotic vehicle 200 has wheels 202, this is merely exemplary and various embodiments may include any variety of components to provide propulsion and maneuvering capabilities, such as treads, paddles, skids, or any combination thereof or of other components.

The robotic vehicle 200 may further include a control unit 210 that may house various circuits and devices used to power and control the operation of the robotic vehicle 200. The control unit 210 may include a processor 220, a power module 230, sensors 240, one or more payload securing units 244, one or more image sensors 245, an output module 250, an input module 260, and a radio module 270.

The processor 220 may be configured with processor-executable instructions to control travel and other operations of the robotic vehicle 200, including operations of various embodiments. The processor 220 may include or be coupled to a navigation unit 222, a memory 224, a gyro/accelerometer unit 226, and a maneuvering data module 228. The processor 220 and/or the navigation unit 222 may be configured to communicate with a server through a wireless connection (e.g., a cellular data network) to receive data useful in navigation, provide real-time position reports, and assess data.

The maneuvering data module 228 may be coupled to the processor 220 and/or the navigation unit 222, and may be configured to provide travel control-related information such as orientation, attitude, speed, heading, and similar information that the navigation unit 222 may use for navigation purposes, such as dead reckoning between Global Navigation Satellite System (GNSS) position updates. The gyro/accelerometer unit 226 may include an accelerometer, a gyroscope, an inertial sensor, an inertial measurement unit (IMU), or other similar sensors. The maneuvering data module 228 may include or receive data from the gyro/accelerometer unit 226 that provides data regarding the orientation and accelerations of the robotic vehicle 200 that may be used in navigation and positioning calculations, as well as providing data used in various embodiments for processing images.

The processor 220 may further receive additional information from one or more image sensors 245 (e.g., a camera, which may be a monocular camera) and/or other sensors 240. In some embodiments, the image sensor(s) 245 may include an optical sensor capable of infrared, ultraviolet, and/or other wavelengths of light. The sensors 240 may also include a wheel sensor, a radio frequency (RF) sensor, a barometer, a sonar emitter/detector, a radar emitter/detector, a microphone or another acoustic sensor, or another sensor that may provide information usable by the processor 220 for movement operations as well as navigation and positioning calculations. The sensors 240 may include contact or pressure sensors that may provide a signal that indicates when the robotic vehicle 200 has made contact with a surface. The payload-securing units 244 may include an actuator motor that drives a gripping and release mechanism and related controls that are responsive to the control unit 210 to grip and release a payload in response to commands from the control unit 210.

The power module 230 may include one or more batteries that may provide power to various components, including the processor 220, the sensors 240, the payload-securing unit(s) 244, the image sensor(s) 245, the output module 250, the input module 260, and the radio module 270. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively or additionally, the power module 230 may be configured to manage its own charging. The processor 220 may be coupled to the output module 250, which may output control signals for managing the motors that drive the rotors 202 and other components.

The robotic vehicle 200 may be controlled through control of the individual motors of the rotors 202 as the robotic vehicle 200 progresses toward a destination. The processor 220 may receive data from the navigation unit 222 and use such data in order to determine the present position and orientation of the robotic vehicle 200, as well as the appropriate course towards the destination or intermediate sites. In various embodiments, the navigation unit 222 may include a GNSS receiver system (e.g., one or more global positioning system (GPS) receivers) enabling the robotic vehicle 200 to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), Wi-Fi access points, cellular network sites, radio station, remote computing devices, other robotic vehicles, etc.

The radio module 270 may be configured to receive navigation signals, such as signals from aviation navigation facilities, etc., and provide such signals to the processor 220 and/or the navigation unit 222 to assist in robotic vehicle navigation. In various embodiments, the navigation unit 222 may use signals received from recognizable RF emitters (e.g., AM/FM radio stations, Wi-Fi access points, and cellular network base stations) on the ground.

The radio module 270 may include a modem 274 and a transmit/receive antenna 272. The radio module 270 may be configured to conduct wireless communications with a variety of wireless communication devices (e.g., a wireless communication device (WCD) 290), examples of which include a wireless telephony base station or cell tower (e.g., the base station 104), a network access point (e.g., the access point 106), a beacon, a smnartphone, a tablet, or another computing device with which the robotic vehicle 200 may communicate (such as the network element 110). The processor 220 may establish a bi-directional wireless communication link 294 via the modem 274 and the antenna 272 of the radio module 270 and the wireless communication device 290 via a transmit/receive antenna 292. In some embodiments, the radio module 270 may be configured to support multiple connections with different wireless communication devices using different radio access technologies.

In various embodiments, the wireless communication device 290 may be connected to a server through intermediate access points. In an example, the wireless communication device 290 may be a server of a robotic vehicle operator, a third party service (e.g., package delivery, billing, etc.), or a site communication access point. The robotic vehicle 200 may communicate with a server through one or more intermediate communication links, such as a wireless telephony network that is coupled to a wide area network (e.g., the Internet) or other communication devices. In some embodiments, the robotic vehicle 200 may include and employ other forms of radio communication, such as mesh connections with other robotic vehicles or connections to other information sources (e.g., balloons or other stations for collecting and/or distributing weather or other data harvesting information).

In various embodiments, the control unit 210 may be equipped with an input module 260, which may be used for a variety of applications. For example, the input module 260 may receive images or data from an onboard camera or sensor, or may receive electronic signals from other components (e.g., a payload).

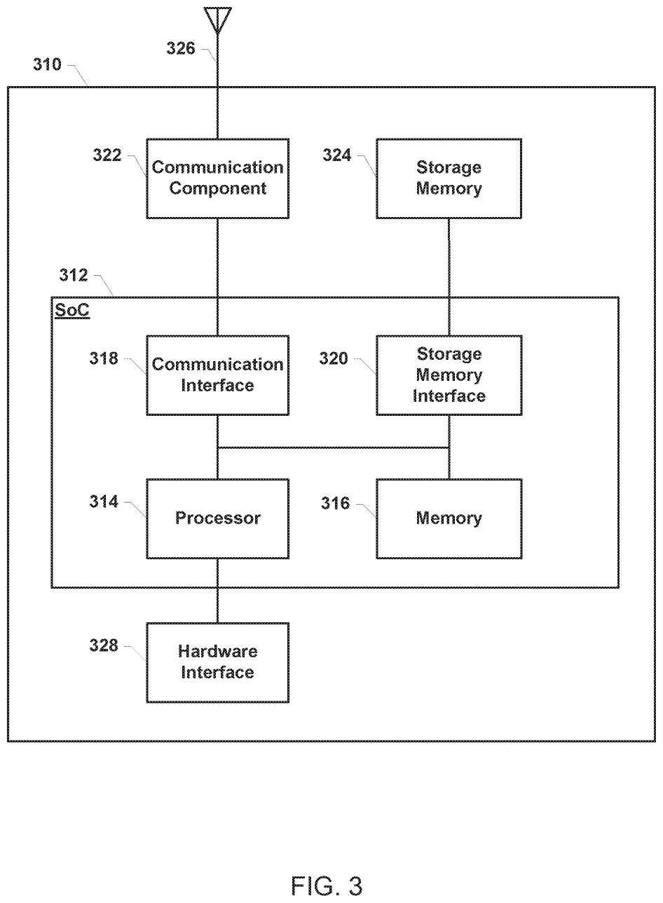

While various components of the control unit 210 are illustrated in FIG. 2 as separate components, some or all of the components (e.g., the processor 220, the output module 250, the radio module 270, and other units) may be integrated together in a single processing device 310, an example of which is illustrated in FIG. 3.

With reference to FIGS. 1-3, the processing device 310 may be configured to be used in a robotic vehicle and may he configured as or including a system-on-chip (SoC) 312. The SoC 312 may include (but is not limited to) a processor 314, a memory 316, a communication interface 318, and a storage memory interface 320. The processing device 310 or the SoC 312 may further include a communication component 322, such as a wired or wireless modem, a storage memory 324, an antenna 326 for establishing a wireless communication link, and/or the like. The processing device 310 or the SoC 312 may further include a hardware interface 328 configured to enable the processor 314 to communicate with and control various components of a robotic vehicle. The processor 314 may include any of a variety of processing devices, for example any number of processor cores.

The term “system-on-chip” (SoC) is used herein to refer to a set of interconnected electronic circuits typically, but not exclusively, including one or more processors (e.g., 314), a memory (e.g., 316), and a communication interface (e.g., 318). The SoC 312 may include a variety of different types of processors 314 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 312 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 312 may include one or more processors 314. The processing device 311 may include more than one SoC 312, thereby increasing the number of processors 314 and processor cores. The processing device 310 may also include processors 314 that are not associated with an SoC 312 (i.e., external to the SoC 312). Individual processors 314 may be multicore processors. The processors 314 may each be configured for specific purposes that may be the same as or different from other processors 314 of the processing device 310 or SoC 312. One or more of the processors 3114 and processor cores of the same or different configurations may be grouped together. A group of processors 314 or processor cores may be referred to as a multi-processor cluster.

The memory 316 of the SoC 312 may be a volatile or non-volatile memory configured for storing data and processor-executable instructions for access by the processor 314. The processing device 310 and/or SoC 312 may include one or more memories 316 configured for various purposes. One or more memories 316 may include volatile memories such as random access memory (RAM) or main memory, or cache memory.

Some or all of the components of the processing device 310 and the SoC 312 may be arranged differently and/or combined while still serving the functions of the various aspects. The processing device 310 and the SoC 312 may not be limited to one of each of the components, and multiple instances of each component may be included in various configurations of the processing device 310.

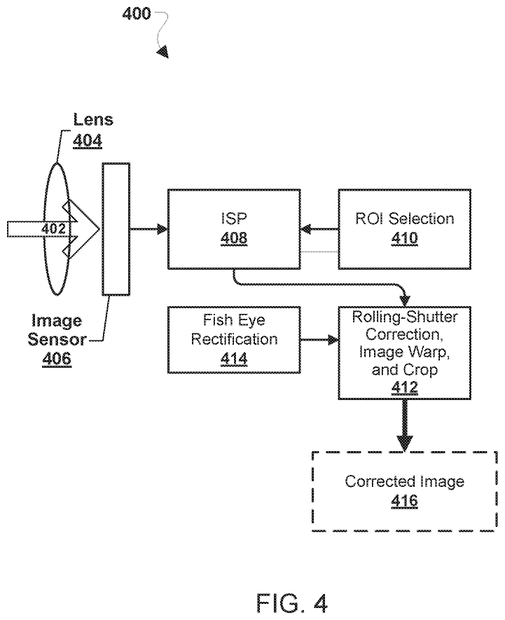

FIG. 4 illustrates an image capture and processing system 400 of a robotic vehicle (e.g., 102, 200 in FIGS. 1 and 2) suitable for use with various embodiments. With reference to FIGS. 1-4, the image capture and processing system 400 may be implemented in hardware components and/or software components of the robotic vehicle, the operation of which may be controlled by one or more processors (e.g., the processor 220, the processing device 310, the SoC 312, and/or the like) of the robotic vehicle.

An image sensor 406 may capture light of an image 402 that enters through a lens 404. The lens 404 may include a fish eye lens or another similar lens that may be configured to provide a wide image capture angle. The image sensor 406 may provide image data to an image signal processing (ISP) unit 408. A region of interest (ROI) selection unit 412 may provide data to the ISP 408 data for the selection of a region of interest within the image data. In some embodiments, the image sensor 406 may be similar to the image sensor 102a, 245.

The ISP 408 may provide image information and ROI selection information to a rolling-shutter correction, image warp, and crop unit 412. A fish eye rectification unit 414 may provide information and/or processing functions to the rolling-shutter correction, image warp, and crop unit 412. In some embodiments, the image rectification unit 414 may provide information and/or processing functions to correct for image distortion caused by the lens 404, an image distortion effect caused by the image sensor 406 (e.g., distortion such as wobble, skew, smear, and the like), or other image distortion.

The rolling-shutter correction and warp unit 412 may provide as output a corrected image 416 based on the cropping, distortion correction, and/or application of the transformation matrix. In some embodiments, the corrected image may include an image having a corrected horizontal orientation or horizontal rotation. In some embodiments, the corrected image may include a stabilized video output.

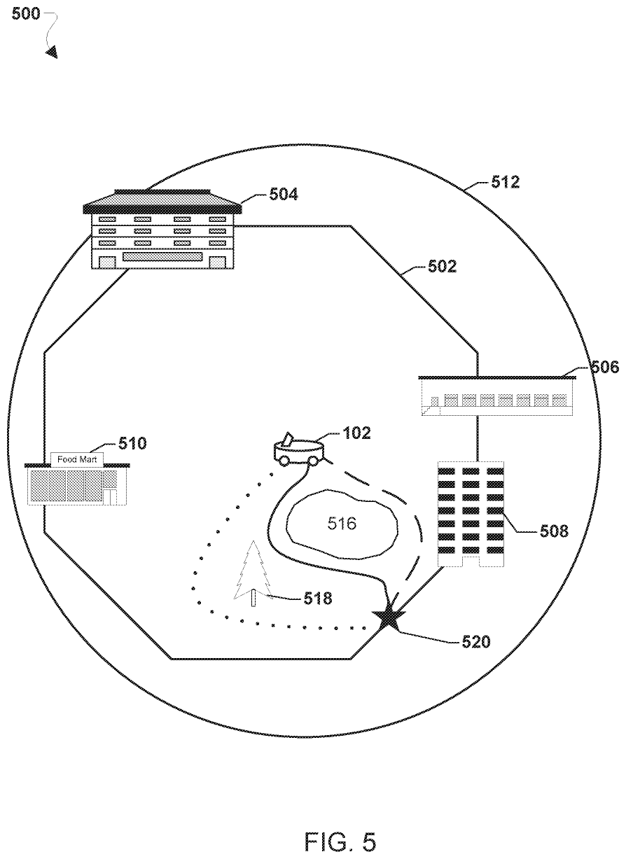

FIG. 5 illustrates an exploration area 500 to be explored by a robotic vehicle (e.g., 102, 200 in FIGS. 1 and 2) suitable for use with various embodiments. With reference to FIGS. 1-5, the robotic vehicle 102 may auto-explore within an exploration region 500, in which a portion of the exploration region 500 may be explored and may be a free area 502. Various structures such as buildings 504, 506, 508, and 510, as well as a lake 516 and a tree 518, may Obstruct or occlude portions of the free area 502. These buildings 504, 506, 508, 510 thus represent an occupied area of the exploration region. Unexplored areas of the exploration region 500 may be unknown area 512 laying outside the free area 502.

During auto-exploration, the robotic vehicle 102a may determine a target position 520 and may engage in path planning in order to find a path from the current robot vehicle position to the target destination that minimize the likelihood that localization will fail while simultaneously minimizing the length of the path. To improve the likelihood that the robotic vehicle will not become lost or disoriented while traveling to the target position, the processor of the robotic vehicle 102a may engage in dynamic path planning based on the environment's feature distribution, generated map data and so on. For example, the processor may modify the path throughout the period in which the robotic vehicle is travelling to the target position.

In various embodiments, the robotic vehicle 102 calculate a cost function for any identified path option. The cost function may include the length of the path, the number of rotations and angle of each of those rotations needed in order to traverse the path, and whether the surrounding environment is feature-rich or feature-poor. Feature-level may be quantified along a scale or according to a number of distinguishable features in an area of the environment (e.g., within a captured image). The path distance “d”, angle of rotation “a”, and feature level “f” may be used to calculate a path cost for each identified path to the target position. For example, the path cost for a given path may be represented by the function:

arg min (γdᵢ+βaᵢ+φfᵢ [Equation 1]

where i is an index of accessible paths, and γ, β, and φ are weights for d, a, and f respectively.

In some embodiments, the robotic vehicle may calculate the path cost for each accessible path and may select the path with the smallest cost function. For example, each time the robotic vehicle stops to rotate, the (processor may recalculate the path cost of available paths to the target position, and select the path with the least rotation and highest feature level. In some embodiments, the processor may only recalculate path costs once the feature level of the area in which the robotic vehicle is presently located drops below a threshold level (i.e., because feature-poor).

Variations in exploration environment may call for adjusting the weights of the cost function. Some environments may be configured such that rotation should be minimized at all costs to avoid the robotic vehicle over turning. In such scenarios, the weight for the angle of rotation a may be increased. Similar adjustments may be made to accommodate for other parameters. In exploration areas where environmental features may be limited, the processor may adjust the weight associated with feature level to prioritize paths near distinguishable features.

As illustrated in FIG. 5, the shortest path to the target position 520 may be the solid line extending between the lake 516 and the tree 518. Although this route is short and progresses through a presumably feature rich area of natural features, it includes multiple rotations that may be difficult for the robotic vehicle 102 to navigate. The dotted line extending around the tree 518 includes a single rotation, but appears to travel through feature-poor terrain where there are no buildings and few natural features. Thus, the dotted path may increase the likelihood that the robotic vehicle will fail to localize and become lost or disoriented. The dashed path extending between the lake 516 and the building 508 travels through feature-rich areas and includes only one or two rotations. Therefore, the dashed path may be the best path for the robotic vehicle 102 to travel in order to ensure that it does not get lost.

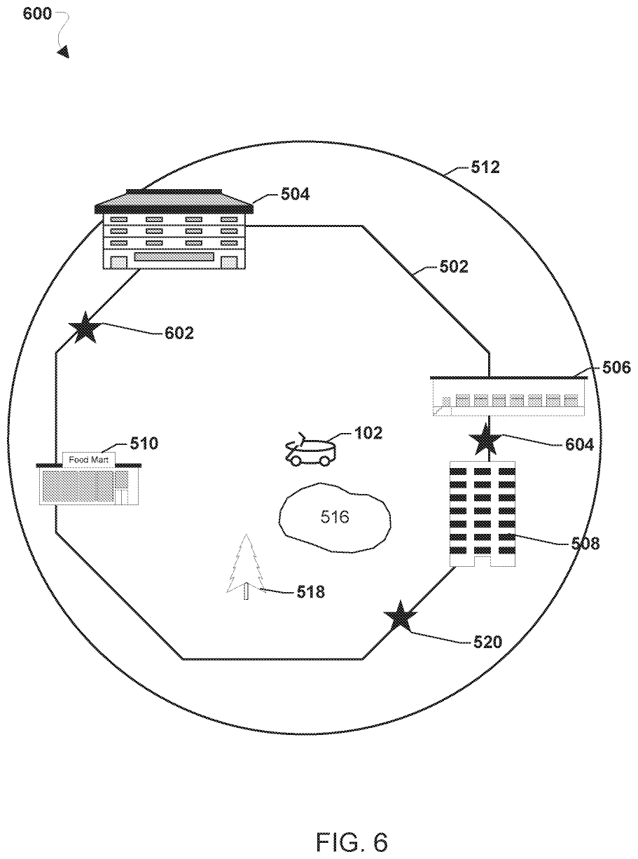

FIG. 6 illustrates an exploration area 600 to be explored by a robotic vehicle (e.g., 102, 200 in FIGS. 1 and 2) suitable for use with various embodiments. With reference to FIGS. 1-6, the processor of the robotic vehicle 102 may select a target position along the frontier region between a free area 502 and an unknown area 512 of the exploration area 600.

In various embodiments, auto-exploration may be frontier-based, and as such a robotic vehicle's target position including the robotic vehicle's localization and orientation is determined based, at least in part on the frontier. In the generated map, there are three states, which may be free, occupied and unknown. In FIG. 6, the area designated by 502 is the free area and the tree 518, the lake 516 and the buildings 504, 506, 508 and 510 are occupied areas of the map. The area designated by 512 is unknown area. Any boundary cell between free area 502 and unknown area 512 may be considered to be a frontier edge cell. Adjacent frontier edge cells may be grouped into frontier regions, such as the dotted lines from 504 to 510, 510 to 508, 508 to 506, and 504 to 506. Any frontier region combined with a number of frontier edge cell in excess of a frontier threshold may be defined as a frontier. For example, the frontier region of the line from 508 to 506 would result in a relatively small frontier edge cell and thus may not be large enough to exceed the frontier threshold necessary to be considered a frontier. The frontier region of the line from 508 to 510 may be large enough to exceed the frontier threshold and be classified a frontier, because it has a large frontier edge cell. In various embodiments, the frontier threshold may be based, at least in part, on the resolution of the map and the robotic vehicle size.

In order to explore more of unknown area 512, a robotic vehicle may move to a position relative to the frontier. In various embodiments, the position relative to the frontier may be referred to as a frontier center. A frontier center may be the target position from which the robotic vehicle well positioned to explore the unknown area effectively. In various embodiments, it could be computed based on the center of one of the dimensions of the map. For example, in a 2-D map,

(x₁, y₁), (x₂, y₂), (x₃, y₃), (x₄, y₄), . . . , (xₖ, yₖ) may represent the contiguous frontier edge cells for one frontier. Various embodiments may determine the maximum and minimum value in x-axis and y-axis xₘₐₓ, xₘᵢₙ, yₘₐₓ, yₘᵢₙ using the frontier edge cells. Then the ranges along the x-axis and y-axis may be determined by [Equation 2] and [Equation 3], respectively. The frontier center (x′ₘ,y′ₘ) may be determined by [Equation 4], which may be selected as the target position if the corresponding frontier is selected as the next frontier to explore. If the determined frontier center is not located at a free, accessible location with rich feature, then the frontier center may be modified to make sure the robotic vehicle would be located in a free area with rich environmental features.

$$\begin{matrix} Δ x = {x}_{max} - {x}_{min} & [ Equation 2 ] \\ Δ y = {y}_{max} - {y}_{min} & [ Equation 3 ] \\ ( {x}_{m}^{′} , {y}_{m}^{′} ) = \{ \begin{matrix}{x}_{m}^{′} = \frac{{x}_{min} + {x}_{max}}{2} , & {y}_{m}^{′} = {y}^{′} , & if Δ x > Δ y \\ {x}_{m}^{′} = {x}^{′} , & {y}_{m}^{′} = \frac{{y}_{min} + {y}_{max}}{2} , & if Δ x < Δ y\end{matrix} \} & [ Equation 4 ]\end{matrix}$$

In various embodiments, each frontier center corresponds to a specific frontier. In the map, there may be multiple frontiers. To select a target position during frontier exploration, the processor of the robotic vehicle 102 may select a frontier to explore. The processor 102 may use the path cost function to select the frontier center as target position among the frontiers that are accessible, feature-rich, and require minimal rotation. Positions 602, 604, and 520 are exemplary frontier centers that may be selected as target positions given the frontier regions of 506 to 508, 508 to 510 and 510 to 504 are all taken as frontiers. The processor may select one of the frontier centers with the smallest path cost. For example, the processor may calculate a path cost for every accessible position from the robotic vehicle to each of frontier centers. The frontier center with the smallest calculated path cost may be selected as the target position.

In various embodiments, the processor may enlarge the area explored during auto-exploration by selecting a target orientation for the robotic vehicle in the target position. The target orientation may be an orientation with reference to the frontier that provides a highly advantageous angle for image capture of the unknown area 512.

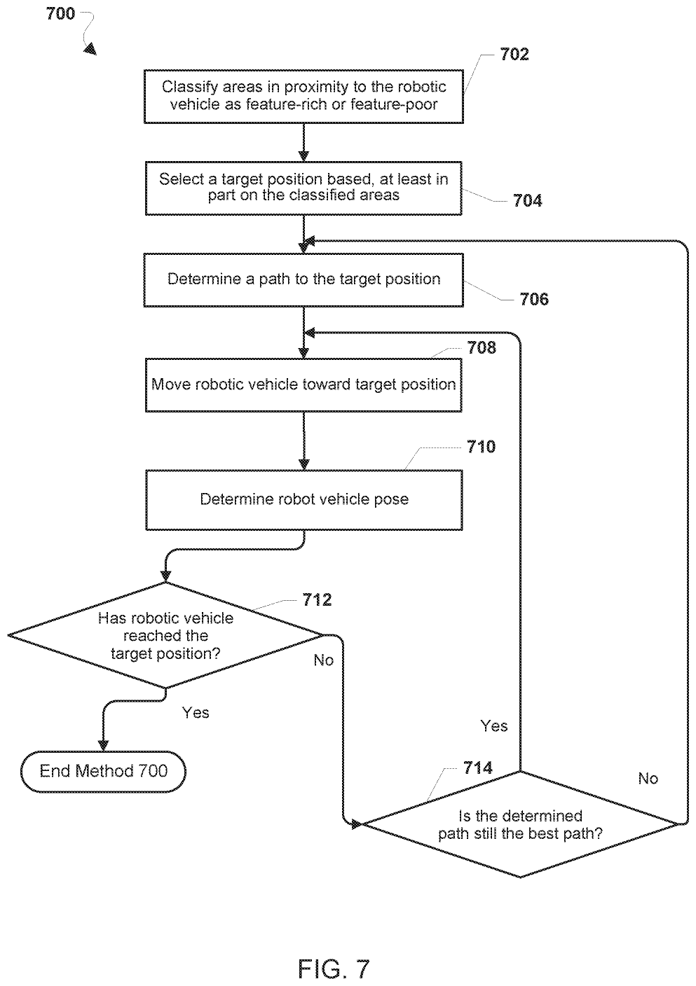

FIG. 7 illustrates a method 700 of controlling auto-exploration in a robotic vehicle according to various embodiments. With reference to FIGS. 1-7, a processor of a robotic vehicle (e.g., the processor 220, the processing device 310, the SoC 312, and/or the like) and hardware components and/or software components of the robotic vehicle may capture and process an image using an image sensor of the robotic vehicle (e.g., the image sensor 245).

In block 702, the processor may classify areas in proximity to the robotic vehicle as feature-rich or feature-poor based, at least in part, on identified environmental features. The processor may analyze images captured by an image sensor of the robotic vehicle to identify environmental features and may then classify the areas from which the images were captured as being feature-rich or feature-poor. Feature-rich areas may be those areas from which the captured images contain numerous distinguishable features. Areas with poor lighting, monotone color palettes, or a lack of physical features may be feature-poor. Conversely, areas with contrasting lighting, numerous physical features, and colorful palettes may be feature-rich. The processor may use a threshold numeric for determining whether an individual area is feature-rich or feature-poor. In some embodiments, the processor may rank or place along a spectrum, the result of the feature analysis and may classify the most feature heavy areas as feature rich.

In block 704, the processor may select a target position from the frontier centers based, at least in part, on the classified areas, the distance from the robotic vehicle to the target position. Target positions may be selected according to a path cost calculated using the feature level of classified areas, angle of rotation, and distance from the robotic vehicle to the target position. The target position may lay along, adjacent to, near, or abutting a frontier near the robotic vehicle.

In block 706, the processor may determine a path from the robotic vehicle to the selected target position based, at least in part, on the classified areas, shortest path distance of trajectory, and smallest rotation angle of the trajectory. More specifically, the processor may calculate a path from the robotic vehicle's current location to the target position. The calculation of the path may attempt to minimize distance, rotation angle, and the amount of distance that the robotic vehicle must cover in feature-poor areas.

In block 708, the processor may initiate movement of the robotic vehicle toward the selected target position. The processor may signal one or more motors and actuators to move the robotic vehicle toward the selected target position.

In block 710, the processor may determine a pose of the robotic vehicle. For example, the processor may determine where the robot vehicle is located and how the robotic vehicle is oriented using one or more sensors. The robotic vehicle may use vision-based, GPS-based, or other form of location determination. For vision-based method, localization techniques may depend on the feature level of the surrounding area and whether the robotic vehicle has visited this area before. This method is described in greater detail with reference to FIGS. 10-12.

In determination block 712, the processor may determine whether the robotic vehicle has reached the target position based on the determined robotic vehicle position and the target position.

In response to determining that the robotic vehicle has reached the target position (i.e., determination block 712=“Yes”), the processor may terminate the method 700. In some embodiments, the processor may return to block 702 and begin identifying and classifying new areas based, at least in part, on their respective environmental features.

In response to determining that the robotic vehicle has not reached the target position (i.e., determination block 712=“No”), the processor may determine whether the determined path is still the best path in determination block 714. For example, the processor may determine whether the path or trajectory that the robotic vehicle is following is still the best path to the target position. The determination may be based, at least in part, on the classification of the area, rotation angle and the distance of the path.

In response to determining that the determined path is not the best path (i.e., determination block 714=“No”), the processor may update the current path by selecting a new path in block 706. If the robotic vehicle has not reached the target position, the processor may need to make sure that the robotic vehicle is still on the right path and in the right position. The robot vehicle may modify a path of the robotic vehicle to the target position based, at least in part, on the localization and the classified areas. Path modification may be necessary or desirable if the robotic vehicle moves into an area in which the feature level drops below an acceptable threshold, or if too much rotation is required of the robotic vehicle. Similarly, path modification may be required if obstacles move into the path of the robotic vehicle.

In response to determining that the determined path is the best path (i.e., determination block 714=“Yes”), the processor may move the robotic vehicle along the determined path in block. 708.

The processor may continue the operations of the method 700 by continuing to move the robotic vehicle toward the target position in block 708 and performing the operations of blocks 710 and 714 until the robotic vehicle reaches the target position (i.e., determination block 712=“Yes”).

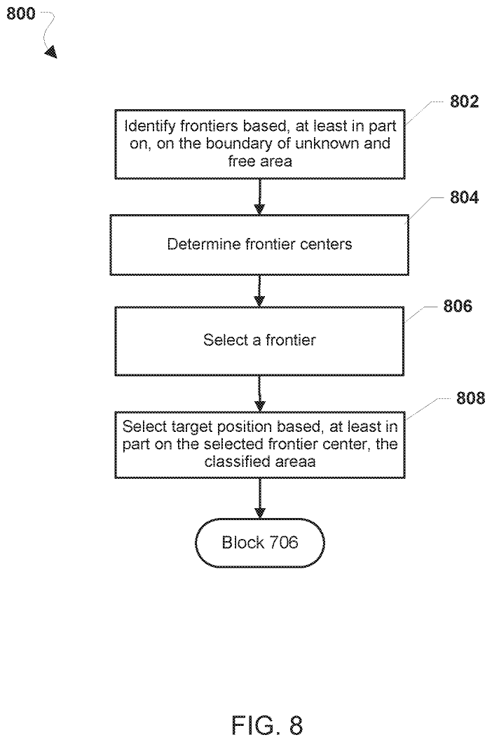

FIG. 8 illustrates a method 800 of target position selection in a robotic vehicle according to various embodiments. With reference to FIGS. 1-8, a processor of a robotic vehicle (e.g., the processor 220, the processing device 310, the SoC 312, and/or the like and hardware components and/or software components of the robotic vehicle may capture and process an image using an image sensor of the robotic vehicle (e.g., the image sensor(s) 245).

In block 802, the processor may identify frontiers of the unknown and free area. More specifically, the processor may identify frontier edge cells in the current map and group the adjacent frontier edges into frontier regions. Using the map resolution and the robotic vehicle size, the processor may filter out the frontier regions that are inaccessible. The remaining frontier regions that meet any conditions may be called frontiers.

In block 804, the processor may determine the frontier center for each frontier. The frontier center may be determined based, at least in part on the geometry of the frontier, the classification of the area.

In block 806, the processor may select a frontier to explore if more than one frontier exists in the generated map. The processor may select the frontier based, at least in part on the path cost of the path from the frontier center to the current robot vehicle. Path costs may be calculated by the processor for each accessible position along the identified boundaries. Positions that are obscured by obstacles or are too small for the robotic vehicle to fit, may be removed from the calculation of a path cost. The remaining, accessible paths may have path costs calculated according to the feature level of the areas in which the path lies, the angle of rotation needed to traverse the path, and the distance along the path. The frontier whose frontier center has the smallest associated path cost may be selected by the processor as the next frontier to explore.

In block 808, the processor may select a target position. In various embodiments, the processor may set the frontier center of the selected frontier as the draft of the target position. The processor may determine a target orientation associated with the target position. The processor may calculate an orientation angle for the robotic vehicle that may provide an advantageous image capture angle with reference to the frontier. By orienting the robotic vehicle such that the image sensor is oriented to the frontier, the processor may increase the area that may be explored from a single target position. The processor may then perform the operations in block 708 of the method 700 as described.

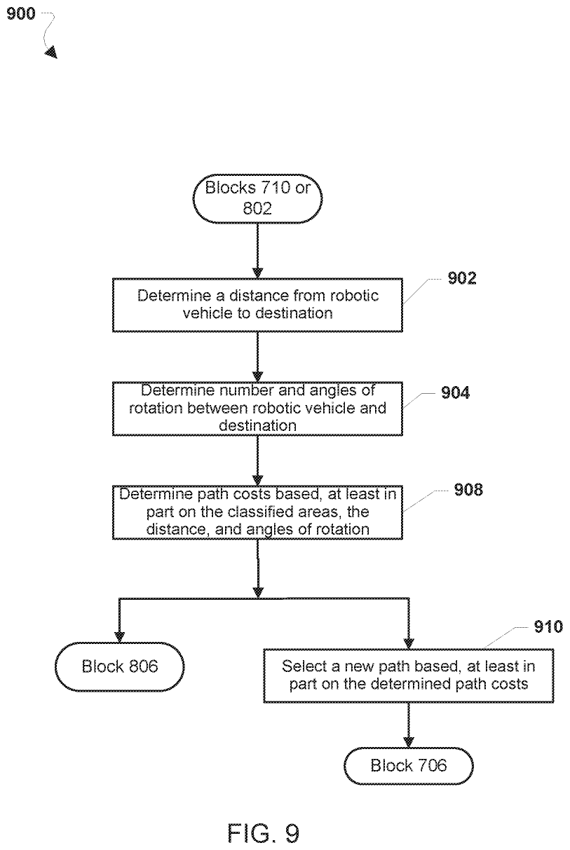

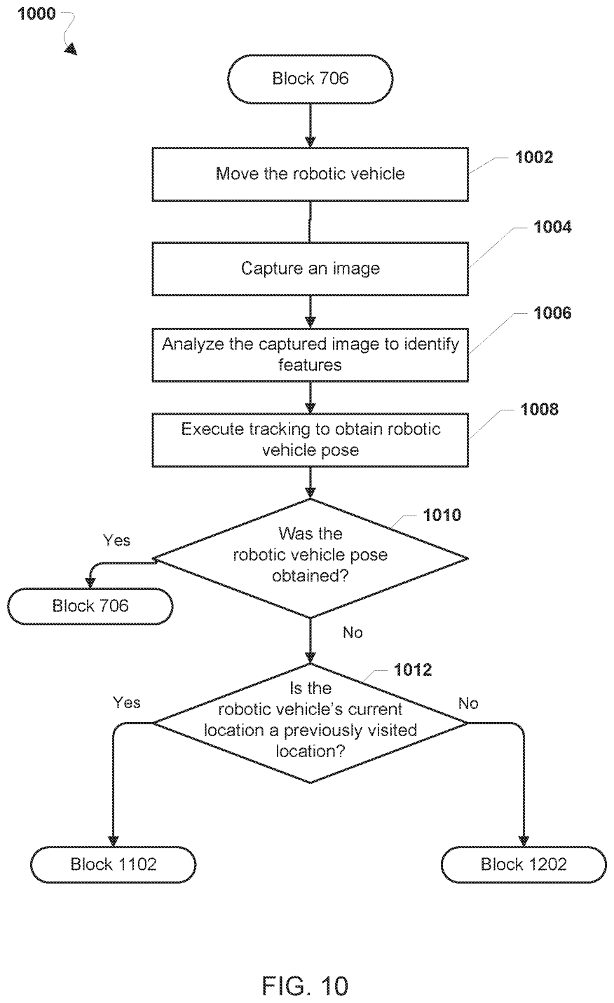

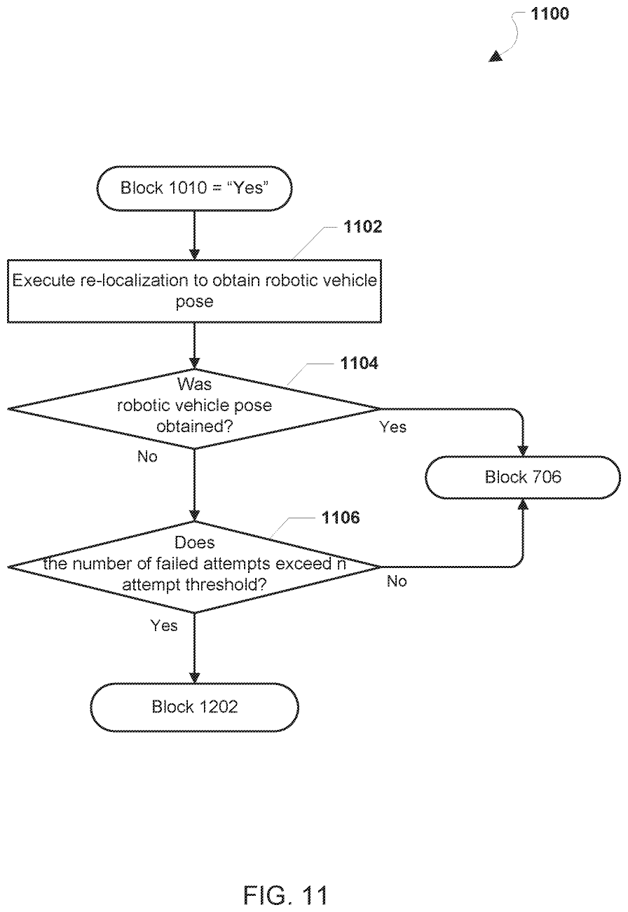

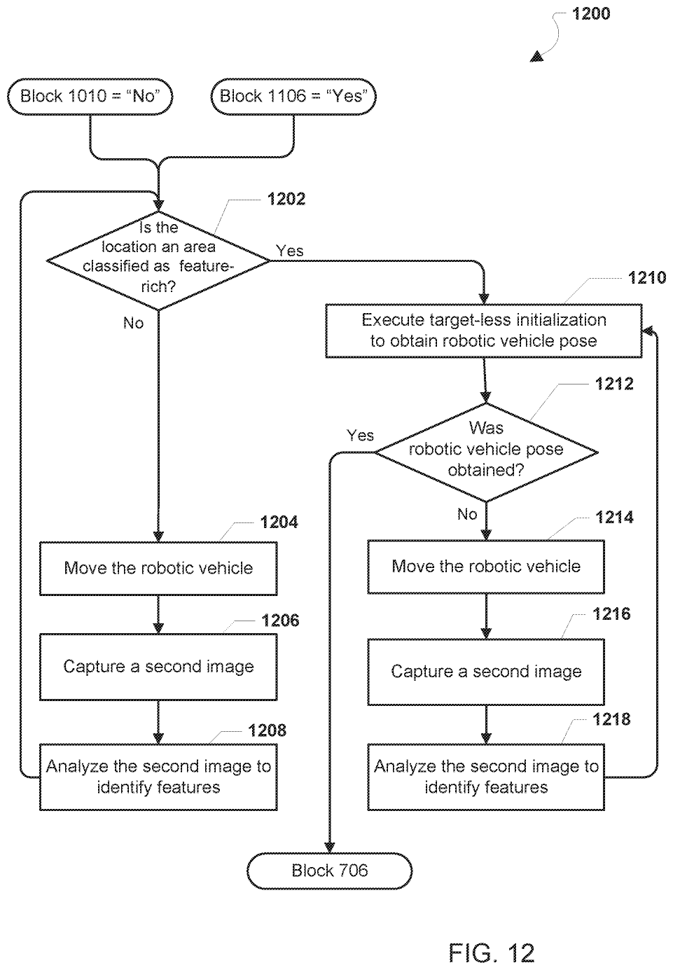

FIG. 9 illustrates a method 900 of path planning in a robotic vehicle according to various embodiments. With reference to FIGS. 1-9, a processor of a robotic vehicle (e.g., the processor 220, the processing device 310, the SoC 312, and/or the like) and hardware components and/or software components of the robotic vehicle may capture and process an image using an image sensor of the robotic vehicle (e.g., the image sensor 245).

The method 900 may be performed by the processor of the robotic vehicle after performing operations of block 710 of the method 700 or operations of block 802 of the method 800 as described.

In block 902, the processor may determine a distance from the robotic vehicle to a destination. The distance between the robotic vehicle and a destination position may be calculated or otherwise determined by the processor along a given path. Thus, a given position may have a number of path distances associated therewith.

In block 904, the processor may determine a number of rotations and angles of the rotations between the robotic vehicle and the destination. Various embodiments may include the processor determining or calculating a total or composite angle of rotation indicating the sum of all rotations that the robotic vehicle must perform in order to reach the target destination. In some embodiments, the most significant angle of rotation may be used by the processor in determining or calculating a path cost. In some embodiments, the processor may only determine or calculate the angle of rotation of the first rotation that the robotic vehicle must perform, and may recalculate path cost after performing the rotation. For example, each time the robotic vehicle must rotate, it may perform path selection anew.

In block 908, the processor may determine a path cost based, at least in part, on the classified areas, the determined distance, and the determined number of rotations and angles of the rotations. The path cost for each position may be determined or calculated according to equation 1 and as described.

In some embodiments, the processor may perform operations of block 806 of the method 800 after calculating the path costs in block 908.

In some embodiments, the processor may select a new path based, at least in part, on the determined path costs in block 910. Paths may thus be modified as the robotic vehicle moves in to areas with different feature levels. The processor may then perform the operations in block 708 of the method 700 as described.

FIG. 10 illustrates a method 1000 of localizing a robotic vehicle after failing to track according to various embodiments. With reference to FIGS. 1-10, a processor of a robotic vehicle (e.g., the processor 220, the processing device 310, the SoC 312, and/or the like) and hardware components and/or software components of the robotic vehicle may capture and process an image using an image sensor of the robotic vehicle (e.g., the image sensor(s) 245). In the method 1000, to decrease localization failure, the robotic vehicle's path trajectory, which may be utilized to determine whether the robotic vehicle has previously visited a location and the environmental feature level may be used to determine whether to perform re-localization or target-less initialization or wait for the robotic vehicle to move to feature-rich environment to perform target-less initialization.

In block 1002, the processor may instruct the various motors and actuators of the robotic vehicle to move the vehicle to a new position.

In block 1004, the image sensor may capture an image of the environment surrounding the robotic vehicle. In block 1006, the processor may analyze the captured image to identify environmental features. For example, the processor may perform image analysis on the captured image to identify any distinguishing features such as lake, trees, or buildings.

In block 1008, the processor may execute tracking to obtain the robotic vehicle's position. In various embodiments, the robotic vehicle processor may compare the captured image and the previously saved key frames/generated map. In performing this comparison, the processor may attempt to match any identified environmental features and thus determine a position relative to those features.

In determination block 1010, the processor may determine whether the robotic vehicle pose was obtained. More specifically, the processor may determine whether processor was successful in attempting to obtain the current pose of the robotic vehicle using tracking techniques.

In response to determining that the robotic vehicle pose was obtained (i.e., determination block 1010=“Yes”), the processor may again determine a path from the robotic vehicle to the selected target position based, at least in part, on the classified areas, shortest path distance of trajectory, and smallest rotation angle of the trajectory in block 706 and continue the method 700 as described.

In response to determining that the robotic vehicle pose is not obtained (i.e., determination block 1010=“No”), the processor may try to estimate the position of robotic vehicle by re-localization or target-less initialization. The selection of one of the two methods may depend on the robotic vehicle trajectory and the environmental feature-level.

In determination block 1012, the processor may determine whether the robotic vehicle's location is in a previously visited location by comparing features identified in the captured image to known features of the area or based on the locations previously visited by the robot vehicle.

In response to determining that the robotic vehicle's location is in a previously visited location (i.e., determination block 1012=“Yes”), the processor may perform re-localization on the captured image as described in greater detail with reference to block 1102 of the method 1100 (FIG. 11).

In response to determining that the robotic vehicle's location is not in a previously visited location (i.e., determination block 1012=“No”), the processor may perform target-less initialization on the captured image as described in greater detail with reference to block 1202 of the method 1200 (FIG. 12).

FIG. 11 illustrates a method 1100 of re-localization in a robotic vehicle according to various embodiments. With reference to FIGS. 1-11, a processor of a robotic vehicle (e.g., the processor 220, the processing device 310, the SoC 312, and/or the like) and hardware components and/or software components of the robotic vehicle may capture and process an image using an image sensor of the robotic vehicle (e.g., the image sensor(s) 245).

In block 1102, the processor may execute re-localization of the robotic vehicle using the captured image. Re-localization techniques may use the current image and the generated map to determine the position of the robotic vehicle. It may rely not only the previous several images but all of the frames. The processor may compare the features identified in the captured image to known elements or features of the generated map and any previous frames stored in a memory of the robotic vehicle in order to establish a current location of the robotic vehicle within the mapped area. For example, in the exploration area 500 of FIG. 5, because the lake 516 lies within the free area 502 and has been explored, the robotic vehicle may use stored images of the lake 516 for comparison to lake features identified in newly captured images in order to determine whether the robotic vehicle is near lake 516. In various embodiments, re-localization may not guarantee that the robotic vehicle estimates its position successfully. Failure may be due to the robotic vehicle being located in an environmental feature-poor area or inaccuracies (luring map generation.

In determination block 1104, the processor may determine whether the robotic vehicle pose was obtained. In response to determining that the robotic vehicle pose was Obtained (i.e., determination block 1104=“Yes”), the processor may again determine a path from the robotic vehicle to the selected target position based, at least in part, on the classified areas, shortest path distance of trajectory, and smallest rotation angle of the trajectory in block 706.

In response to determining that the robotic vehicle pose was not obtained (i.e., determination block 1104=“No”), the processor may count the number of failed attempts at obtaining the pose through re-localization from the first failed attempt with previous image successfully positioned to the current failed attempts and determine whether the number of failed attempts exceeds an attempt threshold in determination block 1106. The attempt threshold may be a designated number of acceptable failures before the processor resorts to other localization methods such as target-less initialization.

In response to determining that the number of failed attempts does not exceed the attempt threshold (i.e., determination block 1106=“No”), the processor may again determine a path from the robotic vehicle to the selected target position based, at least in part, on the classified areas, shortest path distance of trajectory, and smallest rotation angle of the trajectory in block 706 and continue the method 700 as described.

In response to determining that the number of failed attempts exceeds the attempt threshold (i.e., determination block 1106=“Yes”), the processor may perform target-less initialization to estimate the robotic vehicle's position which depends on the environmental feature-level in determination block 1202 of the method 1200 (FIG. 12).

FIG. 12 illustrates a method 1100 of target-less initialization in a robotic vehicle according to various embodiments. With reference to FIGS. 1-12, a processor of a robotic vehicle (e.g., the processor 220, the processing device 310, the SoC 312, and/or the like) and hardware components and/or software components of the robotic vehicle may capture and process an image using an image sensor of the robotic vehicle (e.g., the image sensor(s) 245).

In the determination block 1202, the processor may determine whether the robotic vehicle's location is in an area that is classified as environment feature-rich or not. The processor may reference the classified areas of block 702 of the method 700 to determine the classification of the area in which the robotic vehicle is currently located, or may perform a new classification.

In response to determining that the location is not an area that is classified as feature-rich (i.e., determination block 1202=“No”), the processor may refrain from performing tracking, re-localization, or target-less initialization to compute the robotic vehicle position. The processor may refrain from determining the robotic vehicle position because all of these techniques are vision-based and may require feature-rich environments in order to determine the robotic vehicle pose. Instead, the processor may monitor the environmental feature level of the area in which the robotic vehicle is located while moving the robotic vehicle and analyzing the new captured image. More specifically, the processor may initiate movement of the robotic vehicle in block 11204, capture a second image via the image sensor in block 1206, and analyze the second image for environmental features in block 1208. The processor may again determine whether the robotic vehicle's location is in an area that is classified as environment feature-rich or not in determination block 1202. In various embodiments, the processor may not stop monitoring the environment feature level until the robotic vehicle is located in feature-rich environment (i.e., determination block 1202=“Yes”).

In response to determining that the location of the robotic vehicle is an area that is feature-rich (i.e., determination block 1202=“Yes”), the processor may perform target-less initialization to obtain the robotic vehicle's position in block 1210. Target-less initialization techniques may enable the processor to determine the robotic vehicle position when the robotic vehicle becomes lost while entering an un-visited feature-rich area. In some situations, there may be no related successfully built map for the area nor the previous images. To perform localization such situations, the processor may use target-less initialization. The processor may estimate the robotic vehicle position in a new coordinate frame based on detected image features. A transformation between the previous coordinate frame and the new coordinate frame may be determined using the output of other sensors, such as a wheel-encoder that is reliable even if no feature exists, Using this transformation, the pose from target-less initialization may be transformed to the previous coordinate frame. In some embodiments, such as robotic vehicles having a monocular camera, the determined pose in the new coordinate frame may lack scale information. This scale information may be supplied using another sensor, such as wheel-encoder.

In determination block 1212, the processor may determine whether the robotic vehicle pose was obtained. More specifically, the processor may determine whether the target-less initialization successfully calculated the robotic vehicle's current pose.

In response to determining that the robotic vehicle's pose was not obtained (i.e., determination block 1212=“No”), the process may initiate movement of the robotic vehicle in block 1214, capture a second (or new) image in block 1216, and analyze the second image for environmental features in block 1218. The processor may again perform target-less initialization to obtain the robotic vehicle's position in block 1210. Generally, target-less initialization may use more than one image to finish the processing and obtain the robot vehicle's position. For example, to determine the scale, the processor may need at least two images to determine the distance of how far the robotic vehicle moved between images. Based on this and the output of another sensor such as wheel-encoder, the processor may calculate the scale. Thus, if failing to obtain the pose, the processor may make the robotic vehicle move and capture more images for target-less initialization.

In response to determining that the robotic vehicles pose was obtained (i.e., determination block 1212=“Yes”), the processor may again determine a path from the robotic vehicle to the selected target position based, at least in part, on the classified areas, shortest path distance of trajectory, and smallest rotation angle of the trajectory in block 706 and continue the method 700 as described.

Various embodiments enable the processor of the robotic vehicle to improve the calibration of an image sensor of the robotic vehicle. Various embodiments also improve the accuracy of the robotic vehicle's SLAM capabilities using a more accurately calibrated image sensor. Various embodiments also improve capability of a robotic vehicle to calibrate a monocular image sensor for use with SLAM determinations.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 700, 800, 900 and 1000 may be substituted for or combined with one or more operations of the methods 700, 800, 900 and 1000, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may he accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

1-36. (canceled)

37. A method of controlling auto-exploration by a robotic vehicle, comprising:
classifying, by a processor of the robotic vehicle, areas in proximity to the robotic vehicle as feature-rich or feature-poor based on environmental features identified in captured images;
selecting, by the processor, a target position based, at least in part, on a feature classification level of areas proximate to the robotic vehicle; and
determining, by the processor, a path to the target position based on the feature classification level of areas proximate to the robotic vehicle, a distance between the robotic vehicle and the target position, and a rotation angle parameter associated with the path.

38. The method of claim 37, further comprising:
moving the robotic vehicle part way along the determined path to the selected target position;
determining, by the processor, a pose of the robotic vehicle;
determining, by the processor, whether the robotic vehicle has reached the target position based, at least in part, on the determined pose of the robotic vehicle; and
in response to determining that the robotic vehicle has not reached the target position:
classifying, by the processor, areas in proximity to the pose as feature-rich or feature-poor based on environmental features identified in captured images;
determining, by the processor, whether the determined path traverses an area in which the feature classification level is less than an acceptable threshold; and
determining, by the processor, a new path from the pose of the robotic vehicle to the target position based, at least in part, on the feature classification level of areas proximate to the pose.

39. The method of claim 37, wherein selecting the target position based, at least in part, on the feature classification level of areas proximate to the robotic vehicle comprises:
identifying, by the processor, a plurality of accessible frontiers in a map of the robotic vehicle's location;
determining, by the processor, respective frontier centers of the identified plurality of frontiers; and
selecting, by the processor, a frontier from the identified plurality of accessible frontiers based, at least in part, on the feature classification level of areas along paths to the respective frontier centers.

40. The method of claim 37, wherein determining a path to the target position comprises:
determining, by the processor, a plurality of accessible paths from the robotic vehicle to the target position;
determining, by the processor, feature classification levels of areas traversed by each of the plurality of accessible paths;
determining, by the processor, a distance of each of the plurality of accessible paths from the robotic vehicle to the target position;
determining, by the processor, a number of rotations and angles of the rotations in each of the plurality of accessible paths between the robotic vehicle and the target position; and
selecting, by the processor, one of the plurality of accessible paths to the target position based on the feature classification level of areas traversed by each path, the determined distance of each path, and the determined number of rotations and angles of the rotations in each path.

41. The method of claim 37, further comprising:
capturing, by an image sensor of the robotic vehicle, an image of an environment;
executing, by the processor, tracking on the captured image to obtain a current pose of the robotic vehicle;
determining, by the processor, whether the current pose of the robotic vehicle was obtained;
determining, by the processor, whether the robotic vehicle's current location is a previously visited location in response to determining that the current pose of the robotic vehicle was not obtained; and
performing, by the processor, target-less initialization using the captured image in response to determining that the robotic vehicle's current location is not a previously visited location.

42. The method of claim 41, further comprising in response to determining that the robotic vehicle's current location is a previously visited location:
executing, by the processor, re-localization on the captured image to obtain the current pose of the robotic vehicle;
determining, by the processor, whether the current pose of the robotic vehicle was obtained;
determining, by the processor, whether a number of failed attempts to obtain the current pose of the robotic vehicle exceeds an attempt threshold in response to determining that the current pose of the robotic vehicle was not obtained; and
performing, by the processor, target-less initialization in response to determining that the number of failed attempts to obtain the current pose of the robotic vehicle exceeds the attempt threshold.

43. The method of claim 42, wherein performing target-less initialization using the captured image comprises:
determining, by the processor, whether the robotic vehicle's location is in an area that is classified as feature-rich; and
executing target-less initialization on the captured image to obtain the current pose of the robotic vehicle in response to determining that the robotic vehicle's location is in an area that is classified as feature-rich.

44. The method of claim 43, further comprising moving the robotic vehicle, by the processor, without capturing images for a period of time in response to determining that the robotic vehicle's location is in an area that is not classified as feature-rich.

45. A robotic vehicle, comprising:
an image sensor configured to capture images of an environment; and
a processor coupled to the image sensor and configured with processor-executable instructions to perform operations comprising:
classifying areas in proximity to the robotic vehicle as feature-rich or feature-poor based on environmental features identified in images;
selecting a target position based, at least in part, on a feature classification level of areas proximate to the robotic vehicle; and
determining a path to the target position based on the feature classification level of areas proximate to the robotic vehicle, a distance between the robotic vehicle and the target position, and a rotation angle parameter associated with the path.

46. The robotic vehicle of claim 45, wherein the processor is configured with processor-executable instructions to perform operations further comprising:
moving the robotic vehicle part way along the determined path to the selected target position;
determining a pose of the robotic vehicle;
determining whether the robotic vehicle has reached the target position based, at least in part, on the determined pose of the robotic vehicle; and
in response to determining that the robotic vehicle has not reached the target position:
classifying areas in proximity to the pose as feature-rich or feature-poor based on environmental features identified in images;
determining whether the determined path traverses an area in which the feature classification level is less than an acceptable threshold; and
determining a new path from the pose of the robotic vehicle to the target position based, at least in part, on the feature classification level of areas proximate to the pose.

47. The robotic vehicle of claim 45, wherein the processor is configured with processor-executable instructions to perform operations such that selecting the target position based, at least in part, on the feature classification level of areas proximate to the robotic vehicle comprises:
identifying a plurality of accessible frontiers in a map of the robotic vehicle's location;
determining respective frontier centers of the identified plurality of frontiers; and
selecting a frontier from the identified plurality of accessible frontiers based, at least in part, on the feature classification level of areas along paths to the respective frontier centers.

48. The robotic vehicle of claim 45, wherein the processor is configured with processor-executable instructions to perform operations such that determining a path to the target position comprises:
determining a plurality of accessible paths from the robotic vehicle to the target position;
determining feature classification levels of areas traversed by each of the plurality of accessible paths;
determining a distance of each of the plurality of accessible paths from the robotic vehicle to the target position;
determining a number of rotations and angles of the rotations in each of the plurality of accessible paths between the robotic vehicle and the target position; and
selecting one of the plurality of accessible paths to the target position based on the feature classification level of areas traversed by each path, the determined distance of each path, and the determined number of rotations and angles of the rotations in each path.

49. The robotic vehicle of claim 45, wherein the processor is configured with processor-executable instructions to perform operations further comprising:
receiving from the image sensor an image of the environment;
executing tracking on the image to obtain a current pose of the robotic vehicle;
determining whether the current pose of the robotic vehicle was obtained;
determining whether the robotic vehicle's current location is a previously visited location in response to determining that the current pose of the robotic vehicle was not obtained; and
performing target-less initialization using the image in response to determining that the robotic vehicle's current location is not a previously visited location.

50. The robotic vehicle of claim 49, wherein the processor is configured with processor-executable instructions to perform operations further comprising in response to determining that the robotic vehicle's current location is a previously visited location:
executing re-localization on the image to obtain the current pose of the robotic vehicle;
determining whether the current pose of the robotic vehicle was obtained;
determining whether a number of failed attempts to obtain the current pose of the robotic vehicle exceeds an attempt threshold in response to determining that the current pose of the robotic vehicle was not obtained; and
performing target-less initialization in response to determining that the number of failed attempts to obtain the current pose of the robotic vehicle exceeds the attempt threshold.

51. The robotic vehicle of claim 50, wherein the processor is configured with processor-executable instructions to perform operations such that performing target-less initialization using the image comprises:
determining whether the robotic vehicle's location is in an area that is classified as feature-rich; and
executing target-less initialization on the image to obtain the current pose of the robotic vehicle in response to determining that the robotic vehicle's location is in an area that is classified as feature-rich.

52. The robotic vehicle of claim 51, wherein the processor is configured with processor-executable instructions to perform operations further comprising moving the robotic vehicle without capturing images for a period of time in response to determining that the robotic vehicle's location is in an area that is not classified as feature-rich.

53. A processing device configured for use in a robotic vehicle, wherein the processing device is configured with processor-executable instructions to perform operations comprising:
classifying areas in proximity to the robotic vehicle as feature-rich or feature-poor based on environmental features identified in images;
selecting a target position based, at least in part, on a feature classification level of areas proximate to the robotic vehicle; and
determining a path to the target position based on the feature classification level of areas proximate to the robotic vehicle, a distance between the robotic vehicle and the target position, and a rotation angle parameter associated with the path.

54. The processing device of claim 53, wherein the processing device is configured with processor-executable instructions to perform operations further comprising:
moving the robotic vehicle part way along the determined path to the selected target position;
determining a pose of the robotic vehicle;
determining whether the robotic vehicle has reached the target position based, at least in part, on the determined pose of the robotic vehicle; and
in response to determining that the robotic vehicle has not reached the target position:
classifying areas in proximity to the pose as feature-rich or feature-poor based on environmental features identified in images;
determining whether the determined path traverses an area in which the feature classification level is less than an acceptable threshold; and
determining a new path from the pose of the robotic vehicle to the target position based, at least in part, on the feature classification level of areas proximate to the pose.

55. The processing device of claim 53, wherein the processing device is configured with processor-executable instructions to perform operations such that selecting the target position based, at least in part, on the feature classification level of areas proximate to the robotic vehicle comprises:
identifying a plurality of accessible frontiers in a map of the robotic vehicle's location;
determining respective frontier centers of the identified plurality of frontiers; and
selecting a frontier from the identified plurality of accessible frontiers based, at least in part, on the feature classification level of areas along paths to the respective frontier centers.

56. The processing device of claim 53, wherein the processing device is configured with processor-executable instructions to perform operations such that determining a path to the target position comprises:
determining a plurality of accessible paths from the robotic vehicle to the target position;
determining feature classification levels of areas traversed by each of the plurality of accessible paths;
determining a distance of each of the plurality of accessible paths from the robotic vehicle to the target position;
determining a number of rotations and angles of the rotations in each of the plurality of accessible paths between the robotic vehicle and the target position; and
selecting one of the plurality of accessible paths to the target position based on the feature classification level of areas traversed by each path, the determined distance of each path, and the determined number of rotations and angles of the rotations in each path.

57. The processing device of claim 53, wherein the processing device is configured with processor-executable instructions to perform operations further comprising:
receiving an image of an environment captured by an image sensor of the robotic vehicle;
executing tracking on the image to obtain a current pose of the robotic vehicle;
determining whether the current pose of the robotic vehicle was obtained;
determining whether the robotic vehicle's current location is a previously visited location in response to determining that the current pose of the robotic vehicle was not obtained; and
performing target-less initialization using the image in response to determining that the robotic vehicle's current location is not a previously visited location.

58. The processing device of claim 57, wherein the processing device is configured with processor-executable instructions to perform operations further comprising in response to determining that the robotic vehicle's current location is a previously visited location:
executing re-localization on the image to obtain the current pose of the robotic vehicle;
determining whether the current pose of the robotic vehicle was obtained;
determining whether a number of failed attempts to obtain the current pose of the robotic vehicle exceeds an attempt threshold in response to determining that the current pose of the robotic vehicle was not obtained; and
performing target-less initialization in response to determining that the number of failed attempts to obtain the current pose of the robotic vehicle exceeds the attempt threshold.

59. The processing device of claim 58, wherein the processing device is configured with processor-executable instructions to perform operations such that performing target-less initialization using the image comprises:
determining whether the robotic vehicle's location is in an area that is classified as feature-rich; and
executing target-less initialization on the image to obtain the current pose of the robotic vehicle in response to determining that the robotic vehicle's location is in an area that is classified as feature-rich.

60. The processing device of claim 59, wherein the processing device is configured with processor-executable instructions to perform operations further comprising moving the robotic vehicle without capturing images for a period of time in response to determining that the robotic vehicle's location is in an area that is not classified as feature-rich.

61. A non-transitory processor-readable medium having stored thereon processor-executable instructions configured to cause a processor of a robotic vehicle to perform operations comprising:
classifying areas in proximity to the robotic vehicle as feature-rich or feature-poor based on environmental features identified in images;
selecting a target position based, at least in part, on a feature classification level of areas proximate to the robotic vehicle; and
determining a path to the target position based on the feature classification level of areas proximate to the robotic vehicle, a distance between the robotic vehicle and the target position, and a rotation angle parameter associated with the path.

62. The non-transitory processor-readable medium of claim 61, wherein the stored processor-executable instructions are configured to cause the processor of a robotic vehicle to perform operations further comprising:
moving the robotic vehicle part way along the determined path to the selected target position;
determining a pose of the robotic vehicle;
determining whether the robotic vehicle has reached the target position based, at least in part, on the determined pose of the robotic vehicle; and
in response to determining that the robotic vehicle has not reached the target position:
classifying areas in proximity to the pose as feature-rich or feature-poor based on environmental features identified in images;
determining whether the determined path traverses an area in which the feature classification level is less than an acceptable threshold; and
determining a new path from the pose of the robotic vehicle to the target position based, at least in part, on the feature classification level of areas proximate to the pose.

63. The non-transitory processor-readable medium of claim 61, wherein the stored processor-executable instructions are configured to cause the processor of a robotic vehicle to perform operations such that selecting the target position based, at least in part, on the feature classification level of areas proximate to the robotic vehicle comprises:
identifying a plurality of accessible frontiers in a map of the robotic vehicle's location;
determining respective frontier centers of the identified plurality of frontiers; and
selecting a frontier from the identified plurality of accessible frontiers based, at least in part, on the feature classification level of areas along paths to the respective frontier centers.

64. The non-transitory processor-readable medium of claim 61, wherein the stored processor-executable instructions are configured to cause the processor of a robotic vehicle to perform operations such that determining a path to the target position comprises:
determining a plurality of accessible paths from the robotic vehicle to the target position;
determining feature classification levels of areas traversed by each of the plurality of accessible paths;
determining a distance of each of the plurality of accessible paths from the robotic vehicle to the target position;
determining a number of rotations and angles of the rotations in each of the plurality of accessible paths between the robotic vehicle and the target position; and
selecting one of the plurality of accessible paths to the target position based on the feature classification level of areas traversed by each path, the determined distance of each path, and the determined number of rotations and angles of the rotations in each path.

65. The non-transitory processor-readable medium of claim 61, wherein the stored processor-executable instructions are configured to cause the processor of a robotic vehicle to perform operations further comprising:
receiving an image of an environment captured by an image sensor of the robotic vehicle;
executing tracking on the image to obtain a current pose of the robotic vehicle;
determining whether the current pose of the robotic vehicle was obtained;
determining whether the robotic vehicle's current location is a previously visited location in response to determining that the current pose of the robotic vehicle was not obtained; and
performing target-less initialization using the image in response to determining that the robotic vehicle's current location is not a previously visited location.

66. The non-transitory processor-readable medium of claim 65, wherein the stored processor-executable instructions are configured to cause the processor of a robotic vehicle to perform operations further comprising in response to determining that the robotic vehicle's current location is a previously visited location:
executing re-localization on the image to obtain the current pose of the robotic vehicle;
determining whether the current pose of the robotic vehicle was obtained;
determining whether a number of failed attempts to obtain the current pose of the robotic vehicle exceeds an attempt threshold in response to determining that the current pose of the robotic vehicle was not obtained; and
performing target-less initialization in response to determining that the number of failed attempts to obtain the current pose of the robotic vehicle exceeds the attempt threshold.

67. The non-transitory processor-readable medium of claim 66, wherein the stored processor-executable instructions are configured to cause the processor of a robotic vehicle to perform operations such that performing target-less initialization using the image comprises:
determining whether the robotic vehicle's location is in an area that is classified as feature-rich; and
executing target-less initialization on the image to obtain the current pose of the robotic vehicle in response to determining that the robotic vehicle's location is in an area that is classified as feature-rich.

68. The non-transitory processor-readable medium of claim 67, wherein the stored processor-executable instructions are configured to cause the processor of a robotic vehicle to perform operations further comprising moving the robotic vehicle without capturing images for a period of time in response to determining that the robotic vehicle's location is in an area that is not classified as feature-rich.
